(19) United States
(12) Patent Application Publication
(10) Pub. No.: US 2026/0289840 A1
(43) Pub. Date: Sep. 24, 2026

(54) INFORMATION PROCESSING SYSTEM, INFORMATION PROCESSING METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Kei KAWASAKI, Funabashi-shi (JP); Yuki ICHIOKA, Kawasaki-shi (JP)

(21) Appl. No.: 19/561,513

(22) Filed: Mar. 10, 2026

(30) Foreign Application Priority Data
Mar. 21, 2025 (JP) 2025-047537

(51) Int. Cl. G06T 11/26; G06T 11/60

(52) U.S. Cl. CPC G06T 11/26; G06T 11/60

(57) ABSTRACT

An information processing system acquires a behavior tree corresponding to a prompt describing the behavior of an agent by inputting the prompt into a trained model that has been pre-trained, when a prompt is input, to output a behavior tree representing behavior described by that prompt, displays, on a first display, a first image visually representing the structure of the acquired behavior tree, and accepts a modification to the behavior tree, and displays, on a second display, a second image reproducing an operation of the agent represented by the behavior tree.

### CROSS-REFERENCE TO RELATED APPLICATION

This application claims priority to Japanese Patent Application No. 2025-047537, filed on Mar. 21, 2025, the entire contents of which are incorporated herein by reference.

### TECHNICAL FIELD

The present disclosure relates to an information processing system, an information processing method, and a non-transitory computer readable medium.

### BACKGROUND

Behavior tree (BT) systems that represent the behavior of agents such as robots and characters in games using tree structures composed of multiple nodes are known as technology for controlling the behavior of agents. BT generation tools for generating such BTs are also known. For example, see Patent Literature (PTL) 1.

### CITATION LIST

### Patent Literature

PTL 1: WO 2024/219466 A1

### SUMMARY

However, conventional BT generation tools have room for improvement in terms of ease of generating BTs that represent the desired behavior of agents. Specifically, since the BT generation tools are provided as dedicated tools, it requires time and effort to learn the operations of the tools even in the cases of generating BTs that represent behavior incorporated in advance in the tools. Generating BTs that represent behavior not incorporated in advance in the tools requires advanced coding skills.

It would be helpful to enable easier generation of a BT that specifies desired behavior.

According to the present disclosure, an information processing system is configured to:
acquire a behavior tree corresponding to a prompt describing the behavior of an agent by inputting the prompt into a trained model that has been pre-trained, when a prompt is input, to output a behavior tree representing behavior described by that prompt;
display, on a first display, a first image visually representing the structure of the acquired behavior tree, and accept a modification to the behavior tree; and
display, on a second display, a second image reproducing an operation of the agent represented by the behavior tree.

According to the present disclosure, an information processing method performed by an information processing system, the information processing method includes:
acquiring a behavior tree corresponding to a prompt describing the behavior of an agent by inputting the prompt into a trained model that has been pre-trained, when a prompt is input, to output a behavior tree representing behavior described by that prompt;
displaying, on a first display, a first image visually representing the structure of the acquired behavior tree, and accepting a modification to the behavior tree; and
displaying, on a second display, a second image reproducing an operation of the agent represented by the behavior tree.

According to the present disclosure, a program is configured to cause a computer to execute operations, the operations including:
acquiring a behavior tree corresponding to a prompt describing the behavior of an agent by inputting the prompt into a trained model that has been pre-trained, when a prompt is input, to output a behavior tree representing behavior described by that prompt;
displaying, on a first display, a first image visually representing the structure of the acquired behavior tree, and accepting a modification to the behavior tree; and
displaying, on a second display, a second image reproducing an operation of the agent represented by the behavior tree.

According to one embodiment of the present disclosure, it is possible to more easily generate a BT that specifies desired behavior.

### BRIEF DESCRIPTION OF THE DRAWINGS

In the accompanying drawings:

FIG. 1 illustrates an example of a configuration of an information processing system according to an embodiment of the present disclosure;

FIG. 2 is a block diagram illustrating an example of a hardware configuration of an information processing apparatus in FIG. 1;

FIG. 3 is a block diagram illustrating an example of a hardware configuration of a terminal apparatus in FIG. 1;

FIG. 4 is a block diagram illustrating an example of a functional configuration of the information processing system in FIG. 1;

FIG. 5 is a diagram illustrating an example of a screen displayed on the terminal apparatus;

FIG. 6 is a diagram illustrating an example of an image illustrating the structure of a BT;

FIG. 7 is a diagram illustrating an example of an image for settings of the BT and the attributes of nodes; and

FIG. 8 is a flowchart illustrating an example of operations of the information processing system.

### DETAILED DESCRIPTION

An embodiment of the present disclosure will be described below, with reference to the drawings. In the drawings, portions having the same configuration or function are denoted by the same reference numeral. In the description of the present embodiment, duplicate descriptions of the same portions are in some cases omitted or simplified, as appropriate.

### Information Processing System 1

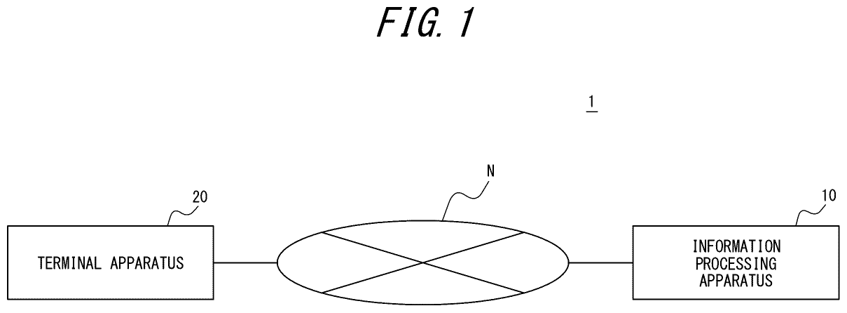

FIG. 1 is a diagram illustrating an example of a configuration of an information processing system 1 according to the embodiment of the present disclosure. The information processing system 1 assists in generating a behavior tree (BT) describing the behavior of an agent. As illustrated in FIG. 1, the information processing system 1 includes an information processing apparatus 10 and a terminal apparatus 20. The information processing apparatus 10 and the terminal apparatus 20 can communicate with each other via a network N.

The information processing apparatus 10 is a computer that assists in generating a BT in response to user instructions via the terminal apparatus 20. The information processing apparatus 10 holds a trained model that has been pre-trained, when a prompt describing the behavior of an agent is input, to output a BT representing the behavior described by that prompt. The information processing apparatus 10 may be, for example, a server apparatus installed in a data center or the like, or a server apparatus belonging to a cloud computing system or other computing systems.

The terminal apparatus 20 is a computer operated by a user. The terminal apparatus 20 accepts instructions from the user and outputs, to the user, the processing results of the information processing apparatus 10 and the terminal apparatus 20 in response to the instructions. The terminal apparatus 20 may access the information processing apparatus 10 via, for example, a web browser or dedicated application software. The terminal apparatus 20 may be, for example, a general purpose electronic device such as a personal computer (PC), smartphone, tablet terminal, or wearable terminal, or a dedicated electronic device.

The network N is any communication medium such as the Internet, an intranet, and a mobile communication network. The information processing apparatus 10 and the terminal apparatus 20 are communicably connected via the network N.

In FIG. 1, one information processing apparatus 10 and one terminal apparatus 20 are illustrated, but the information processing system 1 may include multiple units of these apparatuses. In the present embodiment, the user accesses the information processing apparatus 10 via the terminal apparatus 20, but the present embodiment is not limited to this configuration. For example, the information processing apparatus 10 and the terminal apparatus 20 may be realized by the same computer such as a PC.

In the information processing system 1, the user inputs, to the terminal apparatus 20, a prompt (for example, in natural language or a figure) describing the behavior of an agent. The terminal apparatus 20 transmits the input prompt to the information processing apparatus 10. The information processing apparatus 10 inputs the received prompt into the trained model to acquire a BT corresponding to the prompt. The information processing apparatus 10 displays a first image (including moving images or the like) that visually represents the structure of the acquired BT on a first display of the terminal apparatus 20, and accepts a modification to the BT from the user. The first image functions as a graphical user interface (GUI) that visually displays the structure of the BT and accepts a user operation. The information processing apparatus 10 displays a second image (including moving images or the like) that reproduces an operation of the agent represented by the BT on a second display of the terminal apparatus 20.

As described above, the information processing system 1 automatically generates the BT corresponding to the prompt described in natural language or the like, visually displays the generated BT on the GUI, and accepts the modification to the BT from the user through the GUI. Therefore, the user can directly confirm and modify the result of the automatic generation of the BT, thus facilitating generation of a BT that specifies desired behavior. The information processing system 1 also displays the image reproducing the operation of the agent represented by the BT. This enables the user to efficiently and intuitively evaluate the operation of the generated BT without the need for operations of a simulation system. Therefore, the information processing system 1 can more easily generate a BT that specifies desired behavior.

### Example of Hardware Configuration of Information Processing Apparatus 10

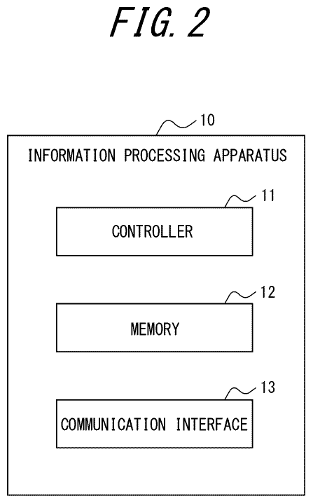

FIG. 2 is a block diagram illustrating an example of the hardware configuration of the information processing apparatus 10 in FIG. 1. As illustrated in FIG. 2, the information processing apparatus 10 includes a controller 11, a memory 12, and a communication interface 13.

The controller 11 includes at least one processor. In one embodiment, the “processor” is a general purpose processor or a dedicated processor specialized for specific processing, but is not limited to these. The controller 11 is communicably connected to each component included in the information processing apparatus 10 and controls operations of the entire information processing apparatus 10.

The memory 12 includes any memory module such as a hard disk drive (HDD), a solid state drive (SSD), read-only memory (ROM), and random access memory (RAM). The memory 12 may function as, for example, a main memory, an auxiliary memory, or a cache memory. The memory 12 stores any information to be used for operations of the information processing apparatus 10. For example, the memory 12 may store a system program, an application program, various types of information received by the communication interface 13, and the like. The memory 12 is not limited to being built into the information processing apparatus 10, and may also be an external database or an external memory module. The memory 12 may be provided as network storage connected to the network N.

The memory 12 stores a trained model that has been pre-trained, when a prompt describing the behavior of an agent is input, to output a BT representing the behavior described by that prompt. The trained model is a model generated by machine learning using a machine learning algorithm. The trained model may be, for example, a machine learning model constructed based on a decision tree, a model generated based on a machine learning algorithm such as convolutional neural network (CNN), recurrent neural network (RNN), or other deep learning techniques.

The trained model may include a language model that includes any dialogue system such as a large language model (LLM) or a chatbot. The language model outputs text or a figure corresponding to a prompt, which is a user instruction, in response to input of the prompt. For example, the information processing apparatus 10 may input a prompt into the language model, and acquire the output result of a BT corresponding to the prompt.

The communication interface 13 includes any communication module capable of communicating with other apparatuses such as scanners using any communication technology. The communication interface 13 may further include a communication control module for controlling communication with other apparatuses, and a memory module for storing communication data such as identification information necessary for communication with other apparatuses.

The functions of the information processing apparatus 10 may be realized by executing a computer program (program) according to the present embodiment on a processor included in the controller 11. That is, the functions of the information processing apparatus 10 are realized by software. The computer program causes a computer to execute the processes of steps included in operations of the information processing apparatus 10, thereby enabling the computer to realize functions corresponding to the processes of the steps. That is, the computer program is a program for causing the computer to function as the information processing apparatus 10 according to the present embodiment.

The computer program can be recorded on a computer readable recording medium. The computer readable recording medium is, for example, a magnetic recording device, an optical disc, a magneto-optical recording medium, or a semiconductor memory. The program is distributed, for example, by selling, transferring, or lending a portable recording medium such as a digital versatile disc (DVD) or a universal serial bus (USB) memory on which the program is recorded. The program may be distributed by storing the program in the storage of a server and transferring the program from the server to another computer via a network. The program may also be provided as a program product.

For example, the computer may temporarily store, in the main memory, the program recorded on the portable recording medium or the program transferred from the server. Then, the computer may read the program stored in the main memory using the processor, and execute processes in accordance with the read program using the processor. The computer may read the program directly from the portable recording medium, and execute processes in accordance with the program. The computer may, each time the program is transferred from the server to the computer, sequentially execute processes in accordance with the received program. Such processing may be executed by a so-called ASP type service that realizes functions merely by execution instructions and result acquisitions, without transferring the program from the server to the computer. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 10 may be realized by a dedicated circuit included in the controller 11. That is, some or all of the functions of the information processing apparatus 10 may be realized by hardware. The information processing apparatus 10 may be realized by a single computer or by the collaboration of multiple computers.

### Example of Hardware Configuration of Terminal Apparatus 20

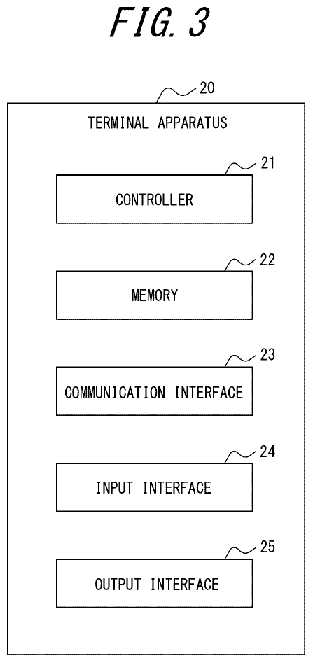

FIG. 3 is a block diagram illustrating an example of a hardware configuration of the terminal apparatus 20 in FIG. 1. The terminal apparatus 20 includes a controller 21, a memory 22, a communication interface 23, an input interface 24, and an output interface 25. The controller 21, memory 22, and communication interface 23 of the terminal apparatus 20 are similar to the controller 11, memory 12, and communication interface 13 of the information processing apparatus 10, so detailed explanations thereof are omitted.

The input interface 24 includes at least one input interface for accepting user input operations and acquiring input information based on the user input operations. For example, the input interface 24 includes a physical key, a capacitive key, a pointing device, a touch screen integrally provided with a display of the output interface 25, a microphone that accepts audio input, or the like, but is not limited to these.

The output interface 25 includes at least one output interface for outputting information to a user and notifying the user. For example, the output interface 25 includes a display for outputting information as images, a speaker for outputting information as audio, or the like, but is not limited to these. Such a display may be, for example, a liquid crystal panel display or an organic electro luminescent (EL) display. The above-described input interface 24 and/or output interface 25 may be configured integrally with the terminal apparatus 20 or may be provided separately.

As with the information processing apparatus 10, the functions of the terminal apparatus 20 may be realized by software or by hardware. The terminal apparatus 20 may be realized by a single computer or by the collaboration of multiple computers that can communicate with each other.

### Example of Functional Configuration of Information Processing System 1

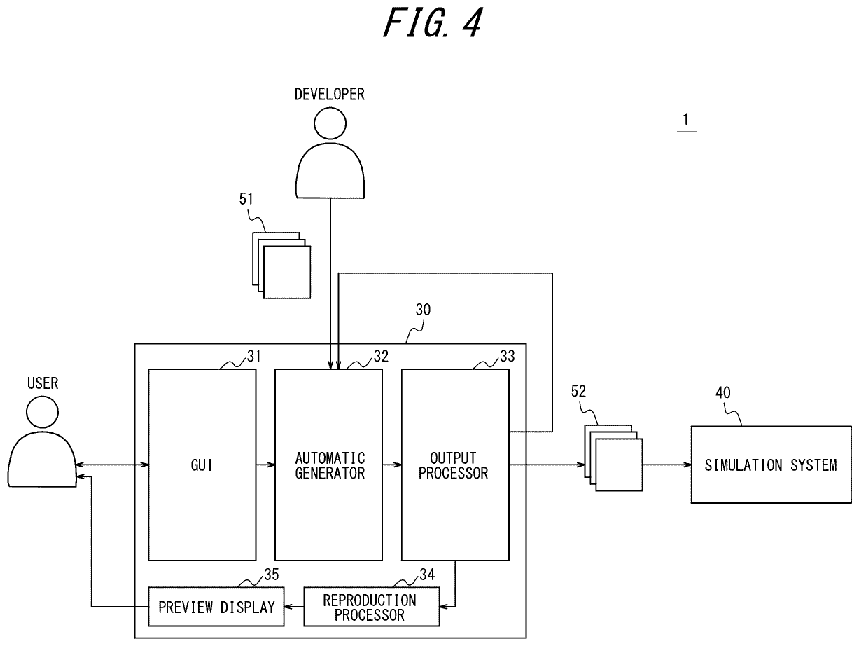

FIG. 4 is a block diagram illustrating an example of a functional configuration of the information processing system 1 in FIG. 1. The information processing system 1 includes a BT generator 30 and a simulation system 40. These functional elements may be realized by the information processing apparatus 10 and/or the terminal apparatus 20 operating based on a program. The simulation system 40 may be realized by a computer other than the information processing apparatus 10 and the terminal apparatus 20.

The BT generator 30 generates a BT based on a prompt in natural language or the like that describes the behavior of an agent, displays the tree structure of the BT to accept a modification, and displays an image reproducing an operation of the agent represented by the BT. The agent may be, for example, a robot, a character in a game, or the like. The BT represents the behavior of the agent through the tree structure that includes multiple nodes (root, control flow, execution, and the like) and edges.

As illustrated in FIG. 4, the BT generator 30 includes, as functional elements, a GUI 31, an automatic generator 32, an output processor 33, a reproduction processor 34, and a preview display 35.

The GUI 31 accepts input of a prompt describing the behavior of an agent from a user, displays an image visually representing the structure of a BT corresponding to the prompt, and accepts a modification to the BT from the user. The prompt may be, for example, in natural language, a figure, or a combination thereof. The GUI 31 may accept a modification to the BT through an operation on the image visually representing the structure of the BT or through input of a prompt. Therefore, the user can easily input the complex behavior of the agent to the BT generator 30 through the GUI 31 using the natural language or figure, even without coding skills. The GUI 31 may be realized in a web browser operating on the terminal apparatus 20, or in dedicated application software.

The automatic generator 32 generates a BT that represents the behavior of the agent described by the prompt, based on the prompt input by the user. The automatic generator 32 may be equipped with a trained model that has been pre-trained, when a prompt describing the behavior of an agent is input, to output a BT that represents the behavior described by that prompt.

A developer of the BT generator 30 may generate the trained model by training a model with standard format training data 51, which includes predefined schemas and corresponding BTs. The standard format training data 51 may include, for example, BT definitions, a custom node library, a subtree library, and/or data for training. The BT definitions are information indicating content defining the BTs. The custom node library is a library of user-definable custom nodes. The subtree library is a library of subtrees, which includes definitions of the subtrees. The data for training is training data that includes samples of BTs and prompts.

The output processor 33 outputs the BT generated by the automatic generator 32 to the reproduction processor 34, or outputs the BT to the simulation system 40 as agent data 52. The agent data 52 is binary data in a specific format that can be read by the simulation system 40.

The reproduction processor 34 generates, based on the BT output from the output processor 33, a preview image that reproduces an operation of the agent represented by the BT. The preview image may be, for example, a still image, moving images, or a combination of these.

The preview display 35 displays the preview image generated by the reproduction processor 34. For example, when the preview image is moving images, the preview display 35 animates the operation of the agent.

The simulation system 40 reads the agent data 52 output from the BT generator 30, and simulates the operation of the agent represented by the agent data 52.

The simulation system 40 reads multiple pieces of agent data 52 and simulates operations of multiple agents. Therefore, setting up and starting the simulation system 40 often require time and effort. In the simulation system 40, operations of agents other than an agent of interest are also simulated. Accordingly, using the simulation system 40 to tune the behavior of a specific agent may be inefficient for adjusting the behavior of the agent of interest.

In contrast, the BT generator 30 generates the preview image that reproduces the operation of the agent based on the BT automatically generated by the reproduction processor 34, and displays the preview image on the preview display 35. Thus, the BT generator 30 has the function of reproducing the operation of the agent specified by the BT, without executing a simulation by the simulation system 40, which would take time and effort. Therefore, the user can easily check whether the generated BT meets desired requirements by checking the preview image.

The user can easily modify the BT through an operation on the image visually representing the structure of the BT in the GUI 31, or through input of a prompt in natural language or the like. In response to the modification to the BT, the BT generator 30 generates a preview image by the reproduction processor 34, and displays the preview image on the preview display 35. As a result, the user can immediately confirm the modification result of the BT, and therefore can efficiently tune the operation of the agent until a desired operation is achieved, through repeated modifications and confirmations of the BT.

Upon obtaining a BT that specifies the desired operation, the user approves the BT. In response, the output processor 33 outputs agent data 52, which can be executed by the simulation system 40, based on the generated BT.

When the user approval for the BT is obtained, the output processor 33 may output a prompt for obtaining the BT and the BT itself to the automatic generator 32. The automatic generator 32 may retrain the trained model using the approved BT, the prompt, and the like as training data. According to such a configuration, it is possible to improve the accuracy of the model tailored to the user without preparing separate training data. When the user approval is obtained, the automatic generator 32 may register the approved BT as a library. This allows the user to call up the library and reuse the BT, thereby improving the efficiency of the entire process.

### Example of Operation

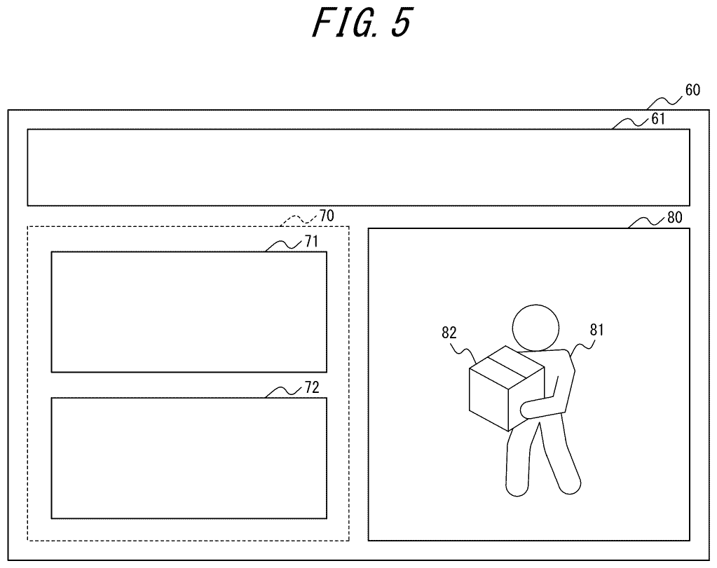

FIG. 5 is a diagram illustrating an example of a screen displayed on the terminal apparatus 20. An image 60 includes an input area 61, a first image 70, and a second image 80.

The input area 61 accepts, from a user, input of a prompt describing the behavior of an agent. In the present embodiment, the prompt is text in the natural language, but for example, voice input from the user may be used as the prompt. Furthermore, the terminal apparatus 20 may accept additional input of a prompt from the user to modify a BT.

The first image 70 visually represents the structure of a BT corresponding to the input prompt, and accepts a modification to the BT. An image 71 visually displays the structure of the BT corresponding to the prompt. An image 72 accepts detailed settings for the BT and for attribute values and the like of nodes and edges constituting the BT.

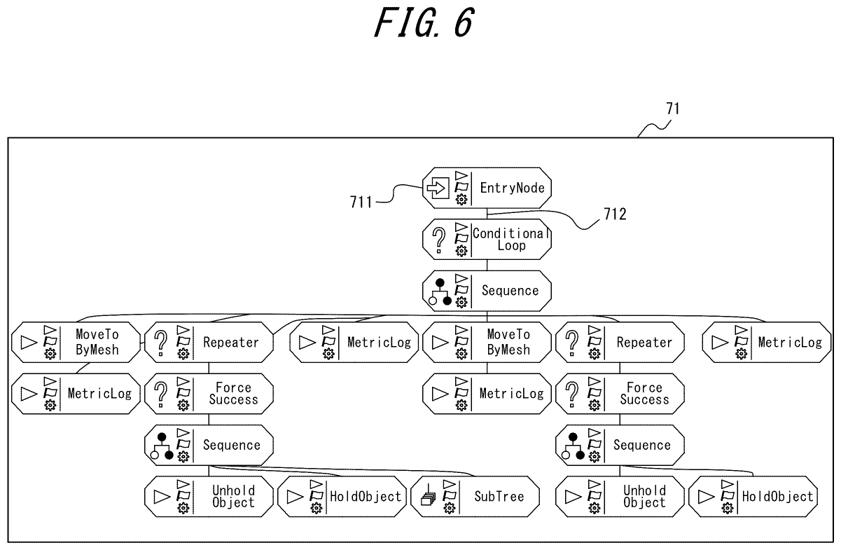

FIG. 6 is a diagram illustrating an example of the image 71 illustrating the structure of the BT. The image 71 includes multiple node images 711 and multiple edge images 712 connecting nodes. The respective node images 711 indicate the meanings of those nodes by displaying terms such as “EntryNode,” “ConditionalLoop,” “Sequence,” and “MoveToByMesh,” by patterns, and the like. For example, the terminal apparatus 20 may allow the user to modify the BT through an operation on the image 71. For example, the terminal apparatus 20 may accept addition and deletion of a node and edge, a change to the attribute, type, and the like of a node and edge, and the like through a selection operation and a drag operation on the images 711 and 712. When the BT is modified by inputting a prompt in natural language from the user, the terminal apparatus 20 may display the image 71 so that a difference from the BT before the modification can be visually distinguished. This allows the user to easily grasp the part of the BT that has been modified. For example, the terminal apparatus 20 may display an added node and edge in a different color than usual, display a deleted node and edge with a specific pattern or the like, or display a node and edge whose attribute and type have been changed with a specific pattern, color, or the like.

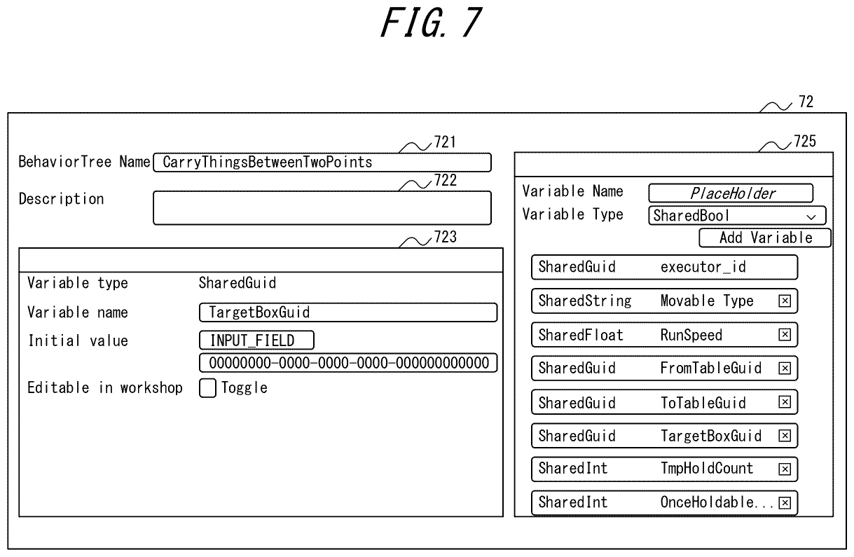

FIG. 7 is a diagram illustrating an example of the image 72 for settings of the BT and the attributes of nodes. An image 721 displays the name of the BT. An image 722 indicates a functional description of the BT. Images 723 and 725 accept the settings, changes, and the like of the variable type, variable name, initial value, editability, and the like of a selected node. By performing necessary settings in the image 72, the user can make a detailed definition of the BT.

The second image 80 in FIG. 5 reproduces an operation of the agent indicated by the BT. In the example in FIG. 5, the BT specifies the operation of the agent, which is a person, carrying a package. The second image 80 displays an image 81 representing the person and an image 82 representing the package through animation. The terminal apparatus 20 may hold the images 81 and 82 as three-dimensional data, and switch the position and direction of observation of the images 81 and 82 or scale up or down the images 81 and 82 according to a user operation.

As in FIG. 5, the terminal apparatus 20 displays both the first image 70 that visually represents the structure of the BT and accepts the user modification, and the second image 80 that reproduces the operation of the agent represented by the BT. Therefore, the user can immediately confirm the operation of the agent due to the modification to the BT. In the present embodiment, a first display that displays the first image 70 and a second display that displays the second image 80 are realized by a display of the output interface 25 of the terminal apparatus 20, but the first display and the second display may be realized by different displays. The terminal apparatus 20 may display a second image 80 reproducing an operation of the agent represented by the BT before the modification and a second image 80 reproducing an operation of the agent represented by the BT after the modification side by side. Since the terminal apparatus 20 displays the second images 80 corresponding to the BTs before and after the modification together, the user can grasp a change in the operation of the agent according to the modification of the BT more easily.

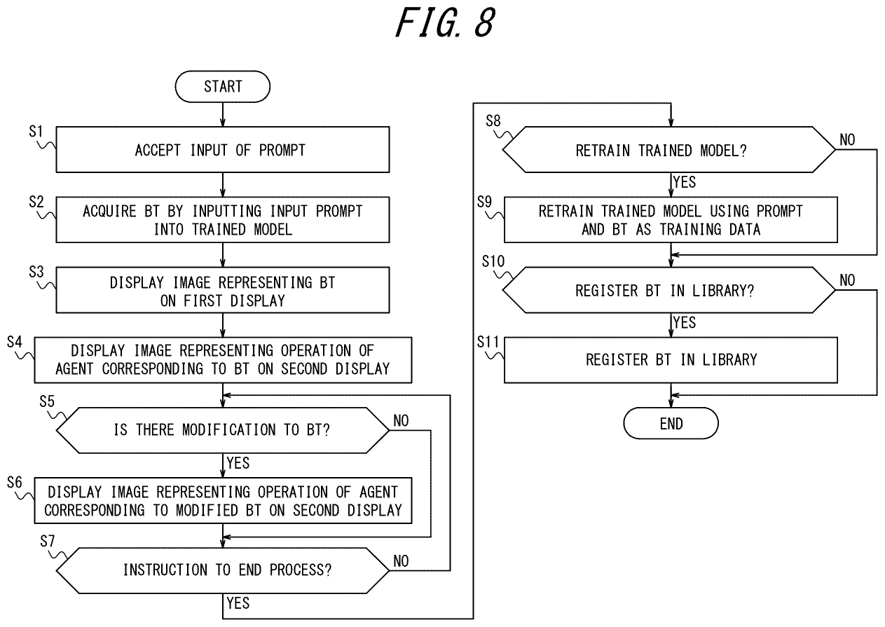

FIG. 8 is a flowchart illustrating an example of operations of the information processing system 1. The operations of the information processing system 1 described with reference to FIG. 8 may correspond to one of information processing methods. The operation of each step in FIG. 8 may be executed based on control by the controller 11 of the information processing apparatus 10 and/or the controller 21 of the terminal apparatus 20.

In S1, the controller 11 accepts input of a prompt from a user. Specifically, the controller 11 may display, for example, the image 60 illustrated in FIG. 5 on the terminal apparatus 20 and accept input of a prompt by causing text in natural language to be input into the input area 61. Alternatively, the controller 11 may accept input of a prompt, for example, by voice input describing an operation of an agent into a microphone of the input interface 24 of the terminal apparatus 20.

In S2, the controller 11 inputs the prompt, which has been input in S1, into the trained model to acquire a BT.

In S3, the controller 11 displays an image representing the BT acquired in S2 on a first display. Specifically, for example, as in the first image 70 in FIG. 5, the controller 11 may display an image 71 representing the structure of the BT and an image 72 for the settings of the attribute values and the like of nodes of the BT on a display of the output interface 25 of the terminal apparatus 20. The controller 11 accepts a modification to the BT from the user through an operation on the image representing the BT, through input of a prompt indicating the modification, or the like.

In S4, the controller 11 displays, on a second display, an image representing an operation of the agent corresponding to the BT acquired in S2. For example, as in the second image 80 in FIG. 5, the controller 11 may display a still image, moving images, or the like representing an operation of the agent on the display of the output interface 25 of the terminal apparatus 20.

In S5, the controller 11 determines whether there is a modification to the BT from the user. When there is a modification to the BT (YES in S5), the controller 11 proceeds to S6. Otherwise (NO in S5), the controller 11 proceeds to S7.

In S6, the controller 11 displays an image representing an operation of the agent corresponding to the modified BT on the second display. For example, as in the second image 80 in FIG. 5, the controller 11 may display a still image, moving images, or the like representing an operation of the agent corresponding to the modified BT on the display of the output interface 25 of the terminal apparatus 20.

In S7, the controller 11 determines whether to end the process. For example, when there is an instruction from the user to end the generation of the BT, the controller 11 may determine that the process should be ended. When the process should be ended (YES in S7), the controller 11 proceeds to S8. Otherwise (NO in S7), the controller 11 returns to S5.

In S8, the controller 11 determines whether to retrain the trained model using the generated BT. For example, the controller 11 may ask the user whether to perform retraining using the generated BT. When an approval for retraining is obtained, the controller 11 may determine that the retraining should be performed. When the retraining should be performed (YES in S8), the controller 11 proceeds to S9. Otherwise (NO in S8), the controller 11 proceeds to S10.

In S9, the controller 11 retrains the trained model using the prompt input from the user and the BT approved by the user as training data. The controller 11 may accept a modification from the user to the prompt and/or BT to be used as training data. This allows the user to retrain the trained model using desired training data.

In S10, the controller 11 determines whether to register the generated BT in a library. For example, the controller 11 may ask the user whether to register the generated BT in a library. When an approval is obtained, the controller 11 may determine that the BT should be registered in the library. When the BT should be registered (YES in S10), the controller 11 proceeds to S11. Otherwise (NO in S10), the controller 11 ends the procedure of the flowchart.

In S11, the controller 11 registers the BT in the library. The controller 11 may register the BT along with a name specified by the user. This allows the user to call a desired BT by the name thereof.

As described above, the information processing system 1 acquires the BT corresponding to the prompt describing the behavior of the agent, by inputting the prompt into the trained model. The trained model is a model that has been pre-trained, when a prompt is input, to output a BT representing the behavior described by that prompt. The information processing system 1 displays the first image 70 (including moving images or the like) that visually represents the structure of the acquired BT on the first display, and accepts the modification to the BT from the user. The information processing system 1 displays the second image 80 (including moving images or the like) that reproduces the operation of the agent indicated by the BT on the second display.

Thus, the information processing system 1 visually displays the generated BT in the GUI (still image, moving images, or the like) such as the first image 70, and accepts the modification. Therefore, the user can directly confirm and modify the result of the automatic generation of the BT, thus facilitating generation of a BT that specifies desired behavior. The information processing system 1 also displays the image reproducing the operation of the agent represented by the BT. This enables the user to efficiently and intuitively evaluate the operation of the generated BT without the need for operations of the simulation system 40. Therefore, the information processing system 1 can more easily generate a BT that specifies desired behavior.

The first display and the second display may be the same. For example, both the first display and the second display may be a display of the output interface 25 of the terminal apparatus 20. According to such a configuration, since the image for confirming and modifying the structure of the BT and the image reproducing the operation of the agent are displayed on the same display, the user can evaluate the operation of the BT efficiently and intuitively while confirming the correspondence between the two. The first display and the second display do not have to be the same.

The prompt may be in the natural language or the figure. According to such a configuration, the user can easily generate the BT simply by inputting the natural language or figure as the prompt. The natural language may be input as text or by the voice of spoken words.

The information processing system 1 may input the prompt indicating the modification to the BT into the trained model, and modify the BT according to the instruction indicated by that prompt. According to such a configuration, the user can modify the BT simply by indicating the modification with the prompt.

The information processing system 1 may reproduce the operation of the agent represented by the modified BT, and display the image representing that operation as the second image on the second display. According to such a configuration, the user can modify and verify the BT efficiently and easily, without operations of the simulation system 40.

The information processing system 1 may re-train the trained model using the prompt and the BT as training data, in response to the user approval. According to such a configuration, the accuracy of the model can be improved without preparing separate training data.

The information processing system 1 may register the BT in the library, in response to the user approval. According to such a configuration, since the final data of the BT is registered in the library, the BT can be reused, and an improvement in the efficiency of the overall process can be expected.

As described above, the configuration according to the present disclosure allows even general users without advanced coding skills to easily define a BT describing the behavior of an agent using natural language, and efficiently verify the operation thereof.

The present disclosure is not limited to the embodiment described above. For example, a plurality of blocks described in the block diagram may be integrated, or a single block may be divided. Instead of executing a plurality of steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these.

[Appendix 1] An information processing system configured to:
acquire a behavior tree corresponding to a prompt describing behavior of an agent by inputting the prompt into a trained model that has been pre-trained, when a prompt is input, to output a behavior tree representing behavior described by that prompt;
display, on a first display, a first image visually representing a structure of the acquired behavior tree, and accept a modification to the behavior tree; and
display, on a second display, a second image reproducing an operation of the agent represented by the behavior tree.

[Appendix 2] The information processing system according to appendix 1, wherein the first image and the second image are displayed on the same display.

[Appendix 3] The information processing system according to appendix 1 or 2, wherein the prompt is in natural language or a figure.

[Appendix 4] The information processing system according to any one of appendices 1 to 3, configured to, by inputting a prompt indicating the modification to the behavior tree into the trained model, modify the behavior tree according to an instruction indicated by that prompt.

[Appendix 5] The information processing system according to any one of appendices 1 to 4, configured to reproduce an operation of the agent represented by the modified behavior tree and display, on the second display, an image representing that operation as the second image.

[Appendix 6] The information processing system according to any one of appendices 1 to 5, configured to, in response to a user approval, retrain the trained model using the prompt and the behavior tree as training data.

[Appendix 7] The information processing system according to any one of appendices 1 to 6, configured to, in response to a user approval, register the behavior tree in a library.

[Appendix 8] An information processing method performed by an information processing system, the information processing method comprising:
acquiring a behavior tree corresponding to a prompt describing behavior of an agent by inputting the prompt into a trained model that has been pre-trained, when a prompt is input, to output a behavior tree representing behavior described by that prompt;
displaying, on a first display, a first image visually representing a structure of the acquired behavior tree, and accepting a modification to the behavior tree; and
displaying, on a second display, a second image reproducing an operation of the agent represented by the behavior tree.

[Appendix 9] The information processing method according to appendix 8, wherein the first image and the second image are displayed on the same display.

[Appendix 10] The information processing method according to appendix 8 or 9, wherein the prompt is in natural language or a figure.

[Appendix 11] The information processing method according to any one of appendices 8 to 10, comprising, by inputting a prompt indicating the modification to the behavior tree into the trained model, modifying the behavior tree according to an instruction indicated by that prompt.

[Appendix 12] The information processing method according to any one of appendices 8 to 11, comprising reproducing an operation of the agent represented by the modified behavior tree and displaying, on the second display, an image representing that operation as the second image.

[Appendix 13] The information processing method according to any one of appendices 8 to 12, comprising, in response to a user approval, retraining the trained model using the prompt and the behavior tree as training data.

[Appendix 14] The information processing method according to any one of appendices 8 to 13, comprising, in response to a user approval, registering the behavior tree in a library.

[Appendix 15] A program configured to cause a computer to execute operations, the operations comprising:
acquiring a behavior tree corresponding to a prompt describing behavior of an agent by inputting the prompt into a trained model that has been pre-trained, when a prompt is input, to output a behavior tree representing behavior described by that prompt;
displaying, on a first display, a first image visually representing a structure of the acquired behavior tree, and accepting a modification to the behavior tree; and
displaying, on a second display, a second image reproducing an operation of the agent represented by the behavior tree.

[Appendix 16] The program according to appendix 15, wherein the first image and the second image are displayed on the same display.

[Appendix 17] The program according to appendix 15 or 16, wherein the prompt is in natural language or a figure.

[Appendix 18] The program according to any one of appendices 15 to 17, comprising, by inputting a prompt indicating the modification to the behavior tree into the trained model, modifying the behavior tree according to an instruction indicated by that prompt.

[Appendix 19] The program according to any one of appendices 15 to 18, comprising reproducing an operation of the agent represented by the modified behavior tree and displaying, on the second display, an image representing that operation as the second image.

[Appendix 20] The program according to any one of appendices 15 to 19, comprising, in response to a user approval, retraining the trained model using the prompt and the behavior tree as training data.

1. An information processing system configured to:
acquire a behavior tree corresponding to a prompt describing behavior of an agent by inputting the prompt into a trained model that has been pre-trained, when a prompt is input, to output a behavior tree representing behavior described by that prompt;
display, on a first display, a first image visually representing a structure of the acquired behavior tree, and accept a modification to the behavior tree; and
display, on a second display, a second image reproducing an operation of the agent represented by the behavior tree.

2. The information processing system according to claim 1, wherein the first image and the second image are displayed on a same display.

3. The information processing system according to claim 1, wherein the prompt is in natural language or a figure.

4. The information processing system according to claim 1, configured to, by inputting a prompt indicating the modification to the behavior tree into the trained model, modify the behavior tree according to an instruction indicated by that prompt.

5. The information processing system according to claim 1, configured to reproduce an operation of the agent represented by the modified behavior tree and display, on the second display, an image representing that operation as the second image.

6. The information processing system according to claim 1, configured to, in response to a user approval, retrain the trained model using the prompt and the behavior tree as training data.

7. The information processing system according to claim 1, configured to, in response to a user approval, register the behavior tree in a library.

8. An information processing method performed by an information processing system, the information processing method comprising:
acquiring a behavior tree corresponding to a prompt describing behavior of an agent by inputting the prompt into a trained model that has been pre-trained, when a prompt is input, to output a behavior tree representing behavior described by that prompt;
displaying, on a first display, a first image visually representing a structure of the acquired behavior tree, and accepting a modification to the behavior tree; and
displaying, on a second display, a second image reproducing an operation of the agent represented by the behavior tree.

9. The information processing method according to claim 8, wherein the first image and the second image are displayed on a same display.

10. The information processing method according to claim 8, wherein the prompt is in natural language or a figure.

11. The information processing method according to claim 8, comprising, by inputting a prompt indicating the modification to the behavior tree into the trained model, modifying the behavior tree according to an instruction indicated by that prompt.

12. The information processing method according to claim 8, comprising reproducing an operation of the agent represented by the modified behavior tree and displaying, on the second display, an image representing that operation as the second image.

13. The information processing method according to claim 8, comprising, in response to a user approval, retraining the trained model using the prompt and the behavior tree as training data.

14. The information processing method according to claim 8, comprising, in response to a user approval, registering the behavior tree in a library.

15. A non-transitory computer readable medium storing a program configured to cause a computer to execute operations, the operations comprising:
acquiring a behavior tree corresponding to a prompt describing behavior of an agent by inputting the prompt into a trained model that has been pre-trained, when a prompt is input, to output a behavior tree representing behavior described by that prompt;
displaying, on a first display, a first image visually representing a structure of the acquired behavior tree, and accepting a modification to the behavior tree; and
displaying, on a second display, a second image reproducing an operation of the agent represented by the behavior tree.

16. The non-transitory computer readable medium according to claim 15, wherein the first image and the second image are displayed on a same display.

17. The non-transitory computer readable medium according to claim 15, wherein the prompt is in natural language or a figure.

18. The non-transitory computer readable medium according to claim 15, wherein the operations comprise, by inputting a prompt indicating the modification to the behavior tree into the trained model, modifying the behavior tree according to an instruction indicated by that prompt.

19. The non-transitory computer readable medium according to claim 15, wherein the operations comprise reproducing an operation of the agent represented by the modified behavior tree and displaying, on the second display, an image representing that operation as the second image.

20. The non-transitory computer readable medium according to claim 15, wherein the operations comprise, in response to a user approval, retraining the trained model using the prompt and the behavior tree as training data.
